(19) United States
(12) Patent Application Publication
(10) Pub. No.: US 2025/0341671 A1
(43) Pub. Date: Nov. 6, 2025

(54) OPTICAL LIGHTGUIDE FOR PROVIDING A PLANAR LIGHT OUTPUT

(71) Applicant: Ventura MFG1, LLC, Zeeland, MI (US)

(72) Inventors: Zachary Fredricks, Zeeland, MI (US); Paul L. Bourget, Zeeland, MI (US)

(21) Appl. No.: 19/196,929

(22) Filed: May 2, 2025

Related U.S. Application Data
(60) Provisional application No. 63/643,179, filed on May 6, 2024.

(51) Int. Cl. F21V 8/00

(52) U.S. Cl. CPC G02B 6/0055; G02B 6/0018

(57) ABSTRACT

An optical lightguide for converting a collimated light input into a planar light output is provided. In one embodiment, the optical lightguide includes a central lens element and first and second lateral lens elements. The central lens element defines an input surface, a first TIR surface, a second TIR surface, and an output surface. The input surface is configured to receive a collimated beam of light, while the first and second TIR surfaces define a first deflection angle and a second deflection angle, respectively, for directing a sub-portion of the received light into the first and second lateral lens elements. The first and second lateral lens elements each define one or more TIR surfaces to direct light forwardly as a planar light output.

### CROSS-REFERENCE TO RELATED APPLICATIONS

The present invention claims priority to U.S. Provisional Patent Application 63/643,179 filed on May 6, 2024, the disclosure of which is hereby incorporated by reference.

### FIELD OF THE INVENTION

The present invention relates to an optical lightguide for converting a collimated light input into a planar light output for a wide range of applications, including automotive and aeronautical applications, such as vehicle headlights and landing gear lights, by example.

### BACKGROUND OF THE INVENTION

Automotive headlights play a vital role in ensuring safe and efficient vehicle operation, especially during low light conditions or adverse weather. Traditional automotive headlights typically consist of a single reflector that directs light emitted from a light source, such as an incandescent or LED bulb, in a specific pattern to illuminate the road ahead. However, the performance of these headlights can be limited by factors such as glare, uneven light distribution, and limited visibility. In order to address these limitations and improve the performance of automotive headlights, there is a need for innovative lighting solutions that can provide a more controlled and efficient distribution of light. One approach to achieving this is by utilizing an array of reflectors, each individually adjustable to direct light in a specific direction and pattern.

By incorporating an array of reflectors into automotive headlights, it is possible to optimize the distribution of light on the road, reduce glare for oncoming traffic, and enhance visibility for the driver. Additionally, the ability to adjust each reflector individually allows for precise control over the light output, enabling custom lighting patterns for various driving conditions. Additionally, a number of optical elements use total internal reflection (TIR) for controlling the movement of light. Example optical elements having a TIR surface include prisms, Fresnel structures, and conic structures. In general, a relationship exists between the area of the TIR surface and the emission area of its nearby light source. As the area of TIR surface relative to the emission area of the light source decreases, the likelihood of losing energy through the TIR surface increases. Consequently, optical systems that use light sources having a large emission area can be prone to undesired efficiency losses. While optical coatings on key surfaces (reflectors or TIR surfaces) are suitable in some applications to limit efficiency losses, optical coatings may not be possible in all applications. For example, manufacturing costs and material incompatibilities can prevent the use of optical coatings in some applications.

### SUMMARY OF THE INVENTION

An optical lightguide for converting a collimated light input into a planar light output is provided. In one embodiment, the optical lightguide includes a central lens element and first and second lateral lens elements. The central lens element defines an input surface, a first TIR surface, a second TIR surface, and an output surface. The input surface is configured to receive a collimated beam of light, while the first and second TIR surfaces define a first deflection angle and a second deflection angle, respectively, for directing a sub-portion of the received light into the first and second lateral lens elements. The first and second lateral lens elements each define one or more TIR surfaces to direct light forwardly as a planar light output.

In one embodiment, the lens body is subdivided into a first lateral lens element, a second lateral lens element, and central lens element disposed between the first and second lateral lens elements. The central lens element defines a planer exit surface that is opposite of the input surface, the input surface having a larger surface area than the planer exit surface. The first lateral lens element and the second lateral lens element are approximately shaped as triangular prisms. The first lateral lens element extends from an upper portion of the central lens element, and the second lateral lens element extends from a lower portion of the central lens element.

In one embodiment, each lateral lens element includes a proximal TIR surface and a distal TIR surface to direct light forwardly, co-planar with light exiting the planer exit surface of the central lens element. In addition, each lateral lens element defines an acute angle with the lens body, optionally an angle of from 2.5° to 15° from horizontal. In these and other embodiments, the optical propagation path is converted from (near) collimated light to (near) planar light, with little to no spillage of light outside of the planar light output. By breaking apart a column of light into parcels, and by passing the parceled beams through limiting apertures before any additional optical manipulations (refraction, reflection, or diffraction), aberrations in the recombined beam are minimized. The optical lightguide can be formed as a molded optic in some embodiments, optionally from a light transmissive silicone material. The optical lightguide is well suited for a wide range of commercial applications, including automotive applications and aeronautical applications. For example, the optical lightguide can be integrated into a vehicle headlight or an aircraft landing light to provide an even light distribution on a roadway or runway without impeding the vision of others. The optical lightguide is not limited to automotive or aeronautical uses, however, as the optical lightguide is well suited for essentially any application in which a planar light output with limited aberration is desired.

These and other features and advantages of the present invention will become apparent from the following description of the invention, when viewed in accordance with the accompanying drawings and appended claims.

Before embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. In addition, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a perspective view of an optical lightguide.

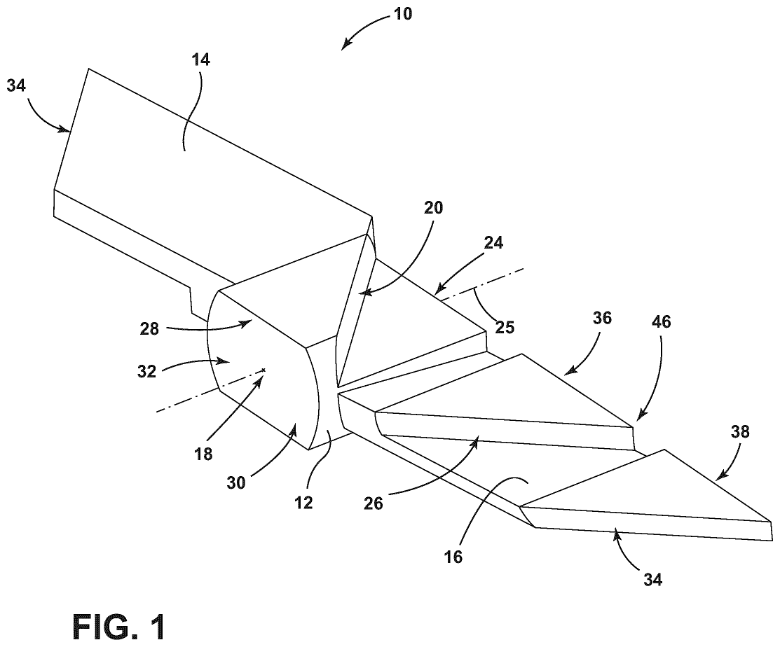

FIG. 2 is a top view of the optical lightguide of FIG. 1.

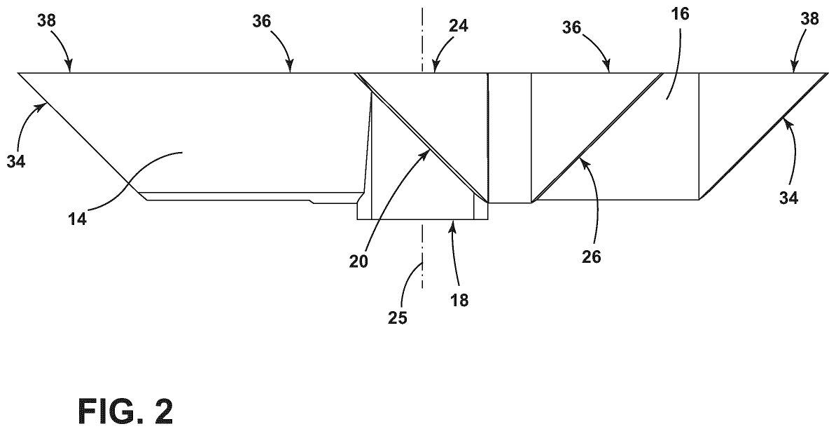

FIG. 3 is a front view of the optical lightguide of FIG. 1.

FIG. 4 is a ray trace diagram of the optical lightguide of FIG. 1.

FIG. 5 is a light output from the optical lightguide of FIG. 1.

FIG. 6 illustrates a Fourier lens with the optical lightguide of FIG. 1.

### DESCRIPTION OF THE CURRENT EMBODIMENT

Referring now to the Figures, an optical lightguide for use with a light emitting device is illustrated and generally designated 10. The optical lightguide 10 includes a central lens element 12, a first lateral lens element 14, and a second lateral lens element 16. The central lens element 12 defines an input surface 18, an upper TIR surface 20, a lower TIR surface 22, and an exit surface 24. The upper and lower TIR surfaces 20, 22 direct some of the collimated light into the first and second lateral lens elements 14, 16, respectively. Each lateral lens element 14, 16 defines a proximal TIR surface 26 and a distal TIR surface 34. The proximal and distal TIR surfaces 26, 34 are configured such that light propagating through the lateral lens elements 14, 16 are reflected forwardly as a planar light output, even with the exit surface 24, and parallel to the optical axis 25 of the collimated light source.

More specifically, the central lens element 12 defines an input surface 18 opposite of an exit surface 24. The central lens element 12 includes an upper portion 28, a lower portion 30, and an intermediate portion 32 therebetween. Generally, the upper portion 28, the lower portion 30, and the intermediate portion 32 are of equal thickness. Opposite of the input surface 18, the upper portion 28 defines the upper TIR surface 20, and the lower portion 30 defines the lower TIR surface 22. Each TIR surface 20, 22 is configured as a hypotenusal surface, however the TIR surfaces 20, 22 can be configured differently in other embodiments. The upper TIR surface 20 and the lower TIR surface 22 are oriented in opposite directions relative to each other.

The surfaces responsible for total internal reflection are not limited to any specific geometric shape and can take on a wide range of configurations to suit various optical applications. These surfaces can be parabolic, cylindrical, hyperbolic, spline-based, ellipsoidal, or freeform. They can include yet other geometries, depending on design requirements, to achieve specific optical effects such as beam shaping, collimation, and focusing. The flexibility in shaping the TIR surfaces 20, 22, 26, 34 enables their use in a wide range of applications, including automotive applications, aeronautical applications, and maritime applications for example.

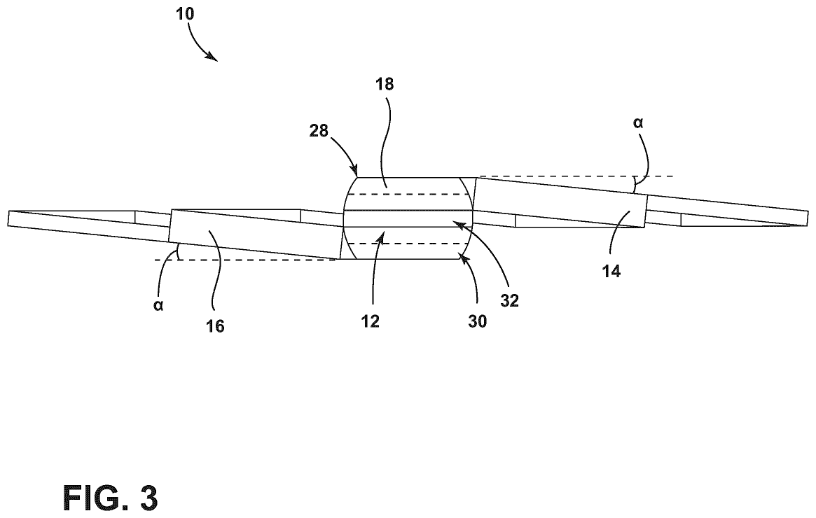

As noted above, the optical lightguide 10 includes first and second lateral lens elements 14, 16 extending from the central lens element 12. The first and second lateral lens elements 14, 16 define an acute angle 36 relative to horizontal (in the orientation illustrated in FIG. 3). In the illustrated embodiment, the acute angle a is an angle of from 2.5° to 15°, alternatively 5° to 10°. The lateral lens elements 14, 16 guide light toward the proximal and distal TIR surfaces 26, 34, where the light is then directed forward. Each of the TIR surfaces 26, 34 are generally about (i.e., ±10%) 45°, while in other embodiments the TIR surfaces 26, 34 can be shaped differently, provided that the light output is directed forwardly.

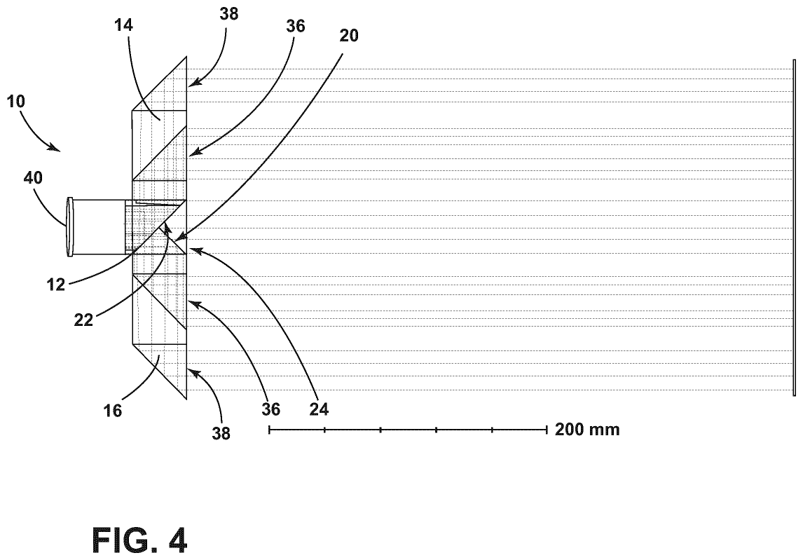

The optical lightguide 10 is configured to receive a collimated beam of light through the input surface 18. As best shown in FIG. 4, the central lens element 12 is configured to separate the collimated beam of light into an undeflected beam, a first (upper) deflected beam, and a second (lower) deflected beam. The undeflected beam is a portion of the collimated beam of light that passes through the central lens element 12 and exits the optical lightguide 10 via the exit surface 24. The first (upper) deflected beam is a portion of the collimated beam of light that passes through the first lateral lens element 14. The first (upper) deflected beam further comprises two sub-beams, a first inner deflected beam and a first outer deflected beam. The first inner deflected beam is a portion of the first deflected beam that is reflected forwardly by the proximal TIR surface 26. The first outer deflected beam is a portion of the first deflected beam that is reflected forwardly by the distal TIR surface 34. The first (upper) deflected beam, including the constituent first inner deflected beam and first outer deflected beam, is deflected forwardly as a planar light output, laterally offset from light emitted from the exit surface 24.

Similarly, the second (lower) deflected beam is a portion of the collimated beam of light that passes through the second lateral lens element 16. The second (lower) deflected beam further comprises two sub-beams, a second inner deflected beam and a second outer deflected beam. The second inner deflected beam is a portion of the second (lower) deflected beam that is reflected forwardly by the proximal TIR surface 26 of the second lateral lens element 16. The second outer deflected beam is a portion of the second (lower) deflected beam that is reflected forwardly by the distal TIR surface 34 of the second lateral lens element 16. The second deflected beam, including the constituent second inner deflected beam and second outer deflected beam, is deflected forwardly as a planar light output, laterally offset from the exit surface 24.

The first (upper) deflected beam and the second (lower) deflected beam are each deflected laterally outward by their respective TIR surfaces 20, 22 through the first lateral lens element 14 and the second lateral lens element 16, respectively. Each lateral lens element 14, 16 is configured to receive its respective deflected beam. The proximal TIR surface 26 of the first lateral lens element 14 and the proximal TIR surface 26 of the second lateral lens element 16 are configured to deflect the first inner deflected beam and the second inner deflected beam through a proximal exit surface 36 of the first lateral lens element 14 and the second lateral lens element 16, respectively. The distal TIR surface 34 of the first lateral lens element 14 and the distal TIR surface 34 of the second lateral lens element 16 are configured to deflect the first outer deflected beam and the second outer deflected beam through a distal exit surface 38 of the first lateral lens element 14 and the second lateral lens element 16, respectively.

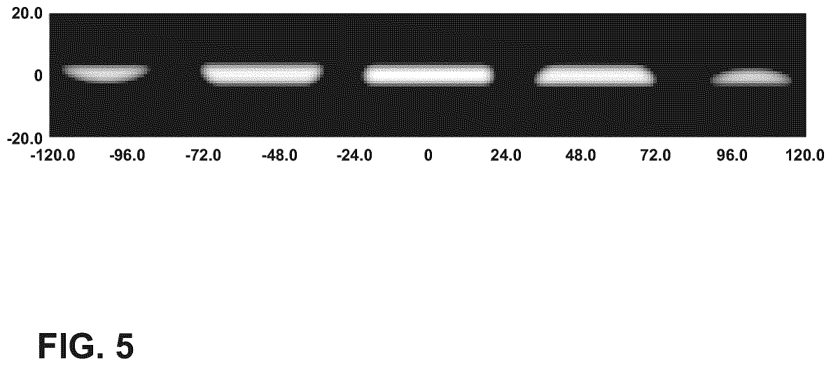

To further illustrate the invention, an optical output of the lightguide 10 is depicted in FIGS. 4 and 5. A light source 40 provides a collimated light output to the lightguide 10. Five discrete light outputs are observed, corresponding to the undeflected beam exiting from the non-deflected exit surface 24, the first inner deflected beam exiting from the inner exit surface 36 of the first lateral lens element 14, the first outer deflected beam exiting from the outer exit surface 38 of the first lateral lens element 14, the second inner deflected beam exiting from the inner exit surface 36 of the second lateral lens element 16, and the second outer deflected beam exiting from the outer exit surface 38 of the second lateral lens element 16.

Various alterations and modifications to the optical lightguide 10 can be implemented without departing from the scope of the invention. For example, front surface reflections may be employed in lieu of TIR conditions in certain embodiments. While TIR is often preferred due to its efficiency, there may be design constraints or functional limitations that make front surface reflection more practical or desirable. In such cases, reflective coatings, such as metallic or dielectric layers, may be applied to selected optical surfaces to redirect light in a controlled manner. These front surface reflections can replicate the optical path redirection typically achieved via TIR. This flexibility allows the optical lightguide 10 to be adapted for a variety of use cases or manufacturing methods while still achieving the desired planar light output.

Furthermore, the addition of collimating optics positioned at or near the entrance aperture of the optical lightguide 10 remains within the scope of the invention. In certain embodiments, the light source may emit a divergent beam profile, as is common with LEDs and other compact solid-state emitters. To optimize coupling efficiency and to maintain the integrity of the desired planar light output, one or more collimating elements (such as refractive lenses or reflective collimators) may be introduced upstream of the optical lightguide 10. These collimating elements function to reduce angular spread and direct the light into a more parallel or quasi-parallel beam, improving the uniformity of light propagation. By conditioning the beam prior to its entry into the optical lightguide 10, the collimating elements help ensure that the optical system maintains low aberration, minimizes light losses, and preserves directional control.

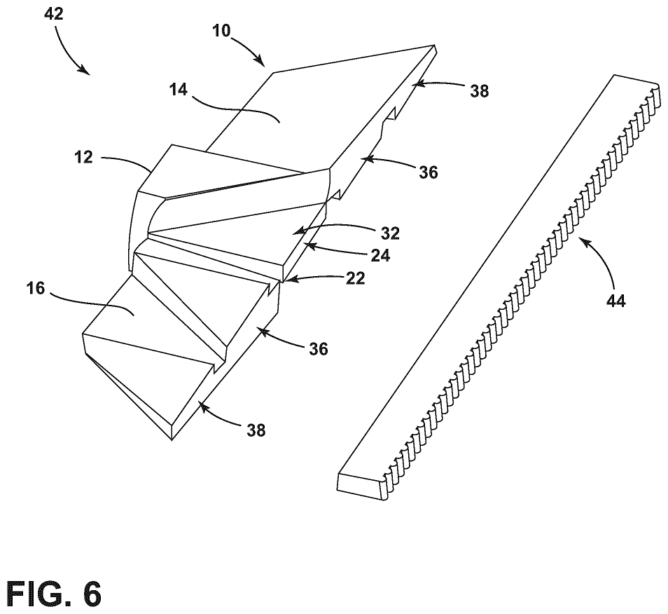

The optical lightguide 10 is optionally provided in an optical lens system 42 as shown in FIG. 6. The optical lens system 42 includes the optical lightguide 10 and a secondary optical element, for example a Fourier lens 44 (other optical elements can be used in combination with the optical lightguide 10 as desired). The Fourier lens 44 is positioned to receive the planar light output from the optical lightguide 10. The Fourier lens 44 converts the horizontal beam into an end use beam. The end use beam in FIG. 6 is useful for low beams in an automobile or other vehicle. However, other embodiments are envisioned, including for example landing lights for aircraft, and other applications in which little to no spillage of light is desired.

The above description is that of current embodiments of the invention. Various alterations and changes can be made without departing from the spirit and broader aspects of the invention as defined in the appended claims, which are to be interpreted in accordance with the principles of patent law including the doctrine of equivalents. Any reference to elements in the singular, for example, using the articles “a,” “an,” “the,” or “said,” is not to be construed as limiting the element to the singular.

1. An optical lightguide for use with a light emitting device, comprising:
a central lens element including an input surface configured to receive a collimated beam of light, an upper total internal reflection (TIR) surface defining a first deflection angle relative to an optical axis of the collimated beam of light, and a lower TIR surface defining a second deflection angle relative to the optical axis of the collimated beam of light, such that the central lens element is configured to separate the collimated beam of light into parceled light; and
a first lateral lens element and a second lateral lens element extending from the central lens element, each of the first and second lateral lens elements including a proximal TIR surface configured to reflect the parceled light forwardly from the optical lightguide as a planar light output that is parallel to the optical axis of the collimated beam of light.

2. The optical lightguide of claim 1, wherein the first lateral lens element and the second lateral lens element each include a distal TIR surface configured to reflect the parceled light forwardly from the optical lightguide as a planar light output.

3. The optical lightguide of claim 1, wherein the first lateral lens element is sloped downward from an upper portion of the central lens element, and wherein the second lateral lens element is sloped upward from a lower portion of the central lens element.

4. The optical lightguide of claim 3, wherein each of the first lateral lens element and the second lens element defines an acute angle relative to horizontal.

5. The optical lightguide of claim 4, wherein the acute angle is between 2.5° to 15°.

6. The optical lightguide of claim 1, wherein:
the upper TIR surface comprises a first hypotenusal surface of the central lens element, opposite of the input surface of the central lens element; and
the lower TIR surface comprises a second hypotenusal surface of the central lens element, opposite of the input surface of the central lens element.

7. The optical lightguide of claim 1, wherein the central lens element and the first and second lateral lens elements are integrally formed from an optical silicone material.

8. The optical lightguide of claim 1, wherein the upper TIR surface and the lower TIR surface each define an angle of 45° relative to the optical axis of the collimated beam of light.

9. The optical lightguide of claim 1, wherein the proximal TIR surface of the first and second lateral lens elements each define an angle of 45° relative to the optical axis of the collimated beam of light.

10. The optical lightguide of claim 1, wherein the input surface of the central lens element defines a height that is greater than a height defined by an exit surface of the central lens element.

11. The optical lightguide of claim 1, wherein one or more of the upper TIR surface, the lower TIR surface, and the proximal TIR surface are hypotenusal, parabolic, cylindrical, hyperbolic, spline-based, or ellipsoidal.

12. An optical lightguide for use with a light emitting device, comprising:
a central lens element, the central lens element defining an input surface, an exit surface, an optical axis therebetween, and a first total internal reflection (TIR) surface, such that the central lens element is configured to separate a collimated beam of light into parceled light; and
a lateral lens element integrally formed with the central lens element, the lateral lens element extending laterally outward from the central lens element and including a proximal TIR surface and a distal TIR surface, wherein each of the proximal TIR surface and the distal TIR surface are configured to reflect the parceled light forwardly from the lateral lens element as a planar light output that is co-planar with light emitted from the exit surface of the central lens element.

13. The optical lightguide of claim 12, wherein the central lens element and the lateral lens element are integrally formed from a silicone material.

14. The optical lightguide of claim 12, wherein the proximal TIR surface comprises a first hypotenusal surface of the lateral lens element, and wherein the distal TIR surface comprises a second hypotenusal surface of the lateral lens element.

15. The optical lightguide of claim 12, wherein the proximal TIR surface of the lateral lens element defines an angle of 45° relative to the optical axis of the central lens element.

16. The optical lightguide of claim 12, wherein the distal TIR surface of the lateral lens element defines an angle of 45° relative to the optical axis of the central lens element.

17. The optical lightguide of claim 12, wherein the lateral lens element is a first lateral lens element, the optical lightguide further comprising a second lateral lens element extending from the central lens element in a direction opposite of the first lateral lens element.

18. The optical lightguide of claim 17, wherein the second lateral lens element includes a proximal TIR surface and a distal TIR surface, wherein each of the proximal TIR surface and the distal TIR surface of the second lateral lens element are configured to reflect the parceled light forwardly from the lateral lens element as a planar light output that is co-planar with light emitted from the exit surface of the central lens element and light emitted from the first lateral lens element.

19. The optical lightguide of claim 17, wherein the central lens element includes a second TIR surface that is configured to reflect light into the second lateral lens element.

20. The optical lightguide of claim 17, wherein the first lateral lens element is sloped downward from an upper portion of the central lens element, and wherein the second lateral lens element is sloped upward from a lower portion of the central lens element.

21. The optical lightguide of claim 17, wherein each of the first lateral lens element and the second lens element defines an acute angle relative to horizontal.

22. The optical lightguide of claim 17, wherein one or more of the first TIR surface, the second TIR surface, the proximal TIR surface, and the distal TIR surface are hypotenusal, parabolic, cylindrical, hyperbolic, spline-based, or ellipsoidal.
